(19) United States
(12) Patent Application Publication
(10) Pub. No.: US 2023/0080143 A1
(43) Pub. Date: Mar. 16, 2023

(54) PLANT GROWING SYSTEM AND METHOD

(71) Applicant: Bio365 LLC, Santa Rosa, CA (US)

(72) Inventor: John Lancaster Gaunt, Ithaca, NY (US)

(73) Assignee: Bio365 LLC, Santa Rosa, CA (US)

(21) Appl. No.: 17/812,432

(22) Filed: Jul. 13, 2022

Related U.S. Application Data
(60) Provisional application No. 63/203,209, filed on Jul. 13, 2021.

(51) Int. Cl. A01G 24/44

(52) U.S. Cl. CPC A01G 24/44

(57) ABSTRACT

A plant growing system, having a plant container made of flexible material, the container having a plurality of air and water exchange pores disposed throughout the flexible material and a cavity defined by the contours of the flexible material, and a volume of living horticultural media disposed inside the cavity. The distribution of the exchange pores, the nutrient profile, and the water retention profile of the living horticultural media promote desired plant growth and characteristics.

### CROSS-REFERENCE TO RELATED APPLICATIONS

This application claims priority under 35 U.S.C. § 119 to U.S. Provisional Application No. 63/203,209, filed Jul. 13, 2021, which is herein incorporated by reference in its entirety.

### FIELD OF INVENTION

The present invention relates to a system and method for plant growth. More specifically, the present invention relates to systems and methods using container dimension to control air and water volumes, in conjunction with macro-pores and micro-pores to provide water drainage and air exchange into the rootzone.

### BACKGROUND OF INVENTION

Plant growth depends on a rooting environment that provides plant roots access to air, water, nutrients, and, in most instances, structure to support plant growth.

A typical plant container is open at the top to facilitate: i) filling the container with growing media, ii) introducing a plant, iii) feeding and watering the plant, and iv) providing holes at the bottom of the pot, to allow for drainage.

In a pot, air exchange between the interior of the plant container and the exterior of the plant container is limited.

The root morphology of plants growing in hard sided containers is influenced by the containers. The dominant affect is that plants are susceptible to root circling, roots circle around the root ball on the inside surface of the container. Often a plant subject to root circling is described as “pot bound”. If pot bound plants are removed from their container and then transplanted into the field this circling can negatively affect root morphology and plant development as the plant continues to grow. To mitigate this effect plastic containers with slot, holes, mesh or similar, and woven porous materials are used to induce root pruning and prevent circling.

The use of air pruning containers has been shown to increase water loss by evaporation. In some situations, this evaporation is seen as a benefit, because it can reduce temperature in the rootzone. However, if such containers are used in a situation such as controlled environment agriculture (CEA) where a plant is grown to maturity in the container, the beneficial aspects of root pruning are mitigated and the evaporation results in uneven drying of containers leading to variations in crop performance. In certain embodiments, changing the container color, for example from black to white, can reduce temperature.

The current invention addresses the issues of moisture management.

### BRIEF SUMMARY OF THE INVENTION

The present disclosure is directed toward systems and methods for plant growth. The present invention also related to using container dimension to control air and water volumes, in conjunction with macro-pores and micro-pores to provide water drainage and air exchange into the rootzone.

In one aspect of the present disclosure provided herein, is a plant growing system having a container having a base having a top side and a bottom side and formed of a flexible material. A side wall having an exterior surface and an interior surface and formed of a flexible material, the side wall encircles the perimeter of the base at a first end and extends from the top side of the base and converges towards a seal at the second end. A cavity is formed within the interior surface of the side wall between the base and the seal, the cavity housing horticultural media. Macropores are disposed at predefined positions on the base and the side wall. Micropores are disposed at predefined positions on the side wall, and the micropores are sized to inhibit fluid exchange between the interior and the exterior of the side wall and to permit air exchange between the interior and the exterior of the side wall. Upon removing the seal, an opening is formed in the container at the second end, and forms a plant growth container.

In another aspect of the present disclosure provided herein, is a method for growing plants by container stacking including providing a plurality of containers having a flexible material, the container further having a plurality of air and water exchange pores disposed throughout the flexible material and a cavity defined by the contours of the flexible material; providing a volume of growing media disposed inside the cavity; providing a stacking container having a flexible material having a plurality of sealed openings, the container further having a plurality of air and water exchange pores disposed throughout the flexible material and an interior cavity defined by the contours of the flexible material, the interior cavity containing growing media; placing a selected planting in contact the growing media of the container; creating an opening in the stacking container; placing the container into the opening of the stacking container; providing drainage by the macropores and disposing the macropores throughout the base and side wall in positions where evaporation is minimal for a selected planting; providing air exchange by the micropores and disposing the micropores throughout the side wall in positions where air exchange is encouraged and evaporation is discouraged for the selected planting; and promoting plant allelopathy.

In another aspect of the present disclosure provided herein, is a plant growing system, having a stacking container having a top and a bottom between a front side opposite a back side, the top and bottom sealed at a first end and a second end, and forming a cavity between the top and bottom and the front side and the back side, the cavity housing horticultural media. Macropores are disposed at predefined positions on the base and the side wall. Micropores are disposed at predefined positions on the top, bottom, and the back side, and the micropores are sized to inhibit fluid exchange between the interior and the exterior of the second container but sized to permit air exchange between the interior and the exterior of the second container. The plant growing system further has a plurality of sealed openings on the top.

These and other objects, features, and advantages of this disclosure will become apparent from the following detailed description of the various aspects of the disclosure taken in conjunction with the accompanying drawings.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments.

FIG. 1A, shows a perspective view of a plant growing system, in accordance with one or more embodiments set forth herein;

FIG. 1B, shows a bottom view of the plant growing system of FIG. 1A, in accordance with one or more embodiments set forth herein;

FIG. 2, shows a perspective view of plant growing system base, in accordance with one or more embodiments set forth herein;

FIG. 3, shows a perspective view of plant growing system base of FIG. 2A with the plant growing system of FIG. 1 containing a planting stacked, in accordance with one or more embodiments set forth herein;

FIG. 4, shows a perspective view of the plant growing system or FIG. 2 with a planting depicted directly in media of the growing system, in accordance with one or more embodiments set forth herein; and

FIG. 5, shows a perspective view of a version of a growing system with a planting, in accordance with one or more embodiments set forth herein.

### DETAILED DESCRIPTION

In the Summary above, and in the Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or which comprises”) components A, B, and C can consist of (i.e., contain only) components A, B, and C, or can contain not only components A, B, and C but also one or more other components.

The current invention provides for growing units that contribute towards providing an ideal rhizosphere biology to support plant signaling, plant pathogen control, and a physical environment to supply air, and water and chemical and biological buffering of nutrient supplied to a growing plant.

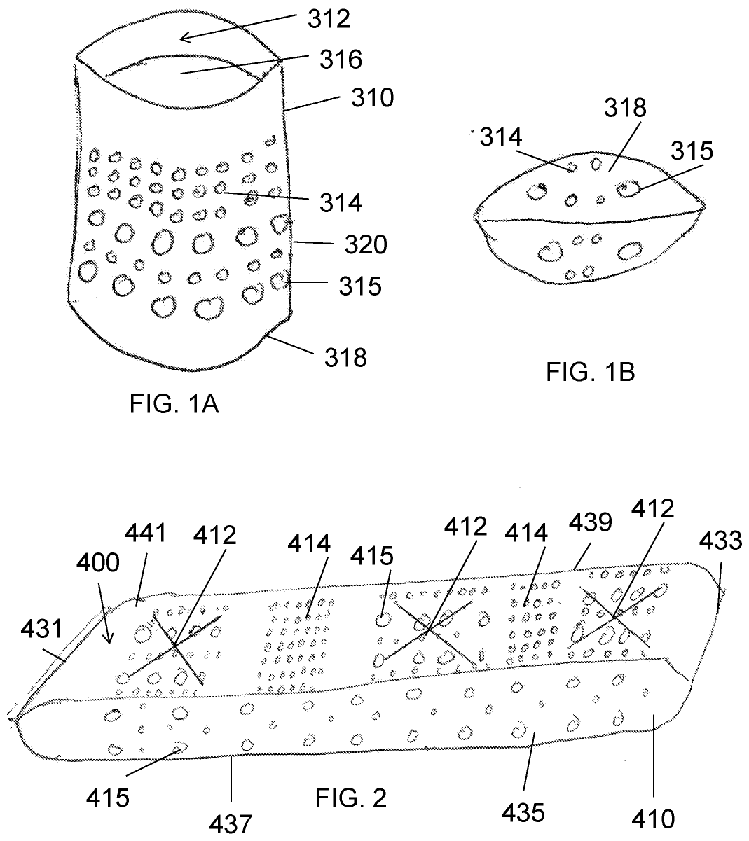

As shown in FIG. 1A, an embodiment of a plant growing system 300, has a cubical, cylindrical, polyhedron, or other three-dimensional shape container 310 with a length, a width, and a height, made of flexible material, with a plant opening 312. The container further has a base 318, made from the same flexible material. The base 318 may have a top side and a bottom side. A side wall 320 may extend out from the circumference of the base 318 at a first end away from the top side and toward a free end or second end, with the side wall 320 circumscribing a cavity (e.g., the plant opening 312) that extends from the second end of the side wall 320 to the base 318. With reference to FIG. 1B the base 318 may be gusseted. The side wall 320 may have an exterior side and an interior side. Referring to FIG. 1, the cavity in container 310 may be filled with living horticultural media.

With reference to FIGS. 1A and 1A, a plurality of air and water exchange pores, including micro perforations 314 (or interchangeably micropores) and macro perforations 315 (or interchangeably macropores) are disposed throughout the flexible material. The macro perforations 314 and the macro perforations 315 extend through the side wall 320 through the exterior side and the interior side, and through the base 318 from the top end to the bottom end.

Macro perforations 315 facilitate exchange of air and water throughout the rootzone. Macro perforations may take the form of punched holes or flaps that allow primarily for drainage but also for exchange of air.

Micro perforations 314 allow for the aeration of the rootzone. Targeted openings 312 are created for introduction of the plant, irrigation devices, and sensors (not shown). Micro perforations may range from less than 0.1 μm to greater than 75 μm, and more specifically, having a range from, for example, approximately 0.1 μm to 20 μm.

In certain embodiments, the second end of the side wall 312 may initially be sealed, such that the cavity may be contained within the interior of the side wall 320 between the base 318 and the sealed second end. The cavity may contain living horticultural media. In such embodiments, the base 318 may be placed on a surface and the sealed end may be unsealed or opened to form the opening 312 of container 310 living horticultural media 316 provided in the container 310 for use by a grower, without the growing having to add living horticultural media.

The container (e.g. container 310) in which a plant is grown can influence the performance of the crop. For example the size of the container, the volume of horticultural media in the container, and the porosity of that media influence the volume or space available for root growth and can be tuned to the specific needs of the plant being grown. The volume of living horticultural media 316 may be disposed inside a cavity defined by the contours of the flexible material. The distribution of the micro perforations 314 and macro perforations 315 may adjust the total air and water filled porosity of the horticultural media 316. The combination of macro perforations and the living horticultural media 316 may also provide for water release in a predetermined way across a tension range of 0 kPa to 1,500 kPa.

Additional elements of embodiments of a growing system include: sensors/perforations for sensors; perforations for watering; dimensions to facilitate “coupling” of multiple system units.

FIG. 2 shows a perspective view of another plant growing system 400, with a plurality of plant openings 412, micro perforations 414, macro perforations, 415. The plant growing system 400 has a top 441 and a bottom 437, and a front side 435 opposite a back side 439, with the front side 435 and the back side 439 positioned between the top 441 and the bottom 437. The top 441 and the bottom 437 may have each have a first end 431 and a second end 433, with the top 441 and the bottom 437 converging to form a seal at the first end 431 and a seal at the second end 433. Thus between the top 441 and the bottom 437 and the front side 435 and the back side 439 a container 410 with an interior cavity may be formed. Container 410 may be formed from a flexible material. Horticultural media 416 may be contained within the cavity.

Macro perforations 415 facilitate exchange of air and water throughout the rootzone. Macro perforations may take the form of punched holes or flaps that allow primarily for drainage but also for exchange of air.

Micro perforations 414 allow for the aeration of the rootzone. Targeted openings 412 are created for introduction of the plant, irrigation devices, and sensors (not shown). Micro perforations may range from less than 0.1 μm to greater than 75 and more specifically, having a range from, for example, approximately 0.1 μm to 20 μm.

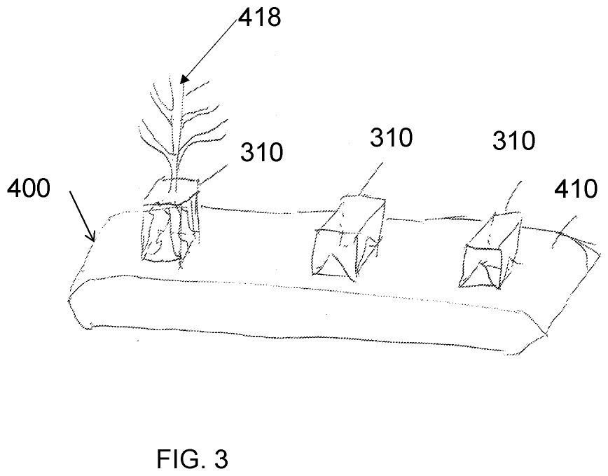

FIG. 3 shows a perspective view of a version of a growing system 400 with the dimensions and physical properties of the growing system 400 designed to account for how a plant 418 is introduced and rooted in a transplant container 310 that is placed on the larger receptor plant container 412. The opening 412 may be such that a growing system 300 may be placed into the opening 412 or stacked, once the opening is unsealed. The geometry of the system is designed to account for the properties of the two containers 310 and 312 separately and combined.

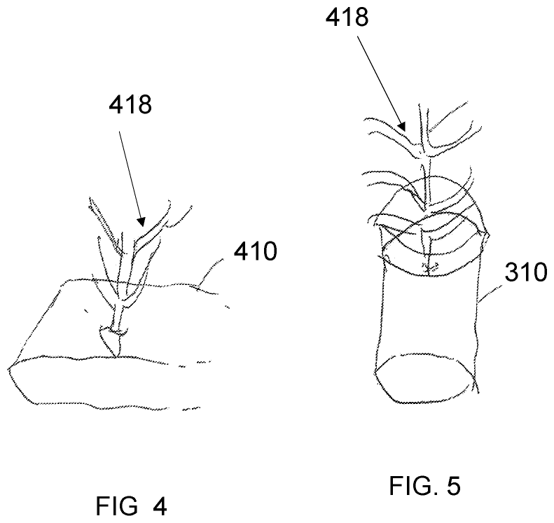

FIG. 4 shows a perspective view of a portion of a version of a growing system with a rooted cutting of a plant 418 in container 310. FIG. 5 shows a perspective view of a version of a growing system with a plain cutting of a plant 418. A plant 418 may be introduced directly as a rooted or unrooted cutting of a plant 418 or young rooted transplant produced by cloning or tissue culture.

Allelopathy is the biological phenomenon by which one organism produces biochemicals that influence the growth, survival, development, and reproduction of other organisms. These biochemicals are known as allelochemicals and have beneficial or detrimental effects on target organisms. Plant allelopathy is one of the modes of interaction between receptor and donor plants and may exert either positive effects (e.g., for agricultural management, such as weed control, crop protection, or crop re-establishment) or negative effects (e.g., autotoxicity, soil sickness, or biological invasion). Sustainable agricultural development may include, for example, exploit cultivation systems that take advantage of the stimulatory/inhibitory influence of allelopathic plants to regulate plant growth and development and to avoid allelopathic autotoxicity. The growing system 400 as shown in FIGS. 2 and 4, provides an advantage in that plants may be able to take use allelopathic effects.

Nutrient supply of the media 316 in all versions of the embodiments described above may be adjusted to meet the requirements of the growing system. This adjustment can be achieved, for example, by adjusting the volume of materials used. As the different particles used to comprise the media 316 have different contribution to nutrient supply, vs delivery of water and air this is not simply a use more or less relationship to adjust nutrients. For example if the nutrient supplying component is contained within materials with smaller particles and with smaller pores or micro perforations 314 (and micro perforations 414), different blending strategies (e.g., different combinations of materials in horticultural media 316, different methods for preparing such mixtures), might need to be deployed to reduce the amount of water held. Further the geometry of the container 410 can be changed to influence the system properties.

In one embodiment of the invention, the micro perforations (e.g., micro perforations 314 and micro perforations 414) are distributed as a 3″ band of micro perforations. The bands of micro perforations are situated on the container to provide full coverage, to face/back only (for sheeting), and any spacing from top or bottom and any spacing between bands. Micro perforations may range in size from less than 0.1 μm to greater than 75 μm.

Macropores may range in size from approximately 0.004″ to approximately 0.014″. Spacing between the holes may be from approximately ¼″ to approximately ⅜″.

Evaporation from the rootzone is not desirable. The micropores 314 distributed throughout the containers in the described embodiments inhibit water exchange and minimize evaporation.

Plant containers invariably contain holes to allow for drainage at times of watering. This prevents waterlogging in the container that would affect root development. Further the dimensions of the container affect both the amount of water retained in pores and the air filled space. The macropores 315 are positioned to provide drainage in desired areas of the rootzone and may be positioned to inhibit evaporation.

In embodiments where a plant is not transplanted but remain in the growing container (e.g., container 310 or container 312), benefits of root pruning around the volume of a container are less obvious. However, air exchange in the root zone is important to the growth of container plants. For example, accumulation of carbon dioxide (CO₂) in the rootzone of container grown plants may have beneficial or negative effects on plant growth. Further, oxygen concentration in the root zone is known to influence the growth of plants in containers. Thus the presence of micropores 314 positioned around the container (e.g., container 310 and container 312) provide for air exchange while inhibiting evaporation.

This invention combines the use of horticultural media porosity, and container dimension to control the volume of air and water held in a container and how it is released to a plant. It then uses macro and micropores to allow drainage of water and exchange of air into the rootzone, at rates that ensure beneficial root condition whilst reducing potential for excessive water loss by evaporation.

The current plant growing system has a container (e.g., container 310 or container 410) with a cubical, cylindrical, polyhedron, or other three-dimensional shape with a length, a width, and a height, made of flexible material, with a plant opening. A plurality of air and water exchange pores may be disposed throughout the flexible material. A volume of living horticultural media may be disposed inside a cavity defined by the contours of the flexible material. The exchange pores may be distributed to achieve water release at tensions from less than 0 kPa to above 1,500 kPa and preferably to achieve water release at tensions between approximately 0 kPa to approximately 1,500 kPa; the nutrient profile of the living horticultural media may release nutrients of differing ratio of nitrogen, phosphorous, potassium, and micro nutrients sufficient to support plant growth over predetermined time profiles.

Additional elements of embodiments of a growing system may include: sensors/perforations for sensors; addition of dices to regulate the tension at which water or fertilizer solution is released to the system; dimensions to facilitate “coupling” of multiple system units

The range of particle size of particles in a rooting environment, the particle densities, and their arrangement in a growing or horticultural media available to the roots, may be provided to control physical properties such as air, water, nutrients supplied to plant roots.

The growing medium is a substance through which plant roots grow and extract water and nutrients. Air spaces in the growing medium allows for aeration of plant roots. Organic components of the growing medium include, but are not limited to, biochar, peat moss, bark, coconut coir, wood fiber, perlite, vermiculite, sand, etc. Growing media may be, for example, held within the plant container. The growing media interacts with the container in which it is held. The dimensions (e.g., length×width×height) of the container will affect, for example, the: i) total amounts of water and, air held, and ii) the distribution of the water and air.

A plant container may be open at the top to provide for: i) adding growing media to the container, ii) introducing a plant into the growing media, iii) feeding and watering the plant, and iv) providing holes at the bottom of the container, to allow for drainage. Such a container may, for example, be a pot.

An alternate container may provide for air exchange between the interior and exterior of the plant container by having holes extending from the exterior to the interior through a side wall of the container. A porous fabric may also be used in conjunction with the plant container having holes.

Growing plants in containers may be done as part of cultivation strategies for Controlled Environment Agriculture (CEA). CEA is defined as a combination of engineering, plant science, and computer managed greenhouse control technologies used to optimize plant growing systems, plant quality, and production efficiency. CEA systems allow stable control of the plant environment including temperature, light, and CO2. CEA also provides separate control of the root-zone environment. CEA provides secure, healthy, and cost-effective year-round production of many premium edible, ornamental, and high value plant species.

CEA Production may consider production efficiency (yield/unit input) and also may consider quality traits or chemotype. Chemotype may be influenced by the expression of plant secondary metabolites but it is not a fixed character of a particular plant. However, plants continuously adjust their growth and physiology in response to a complex network of interacting molecules that enable cells to sense, integrate, and respond to intricate environmental signals. Thus, chemotype is better described as a trait that is influenced by the interaction between plant genetics and the environment. The environment may include factors such as water and nutrient stress, temperature, light, humidity.

Chemotype may be a trait considered in CEA production, but it may also be used in other cultivation strategies.

Overall, the present system allows for optimization of the growing environment for horticultural crops in CEA. The present system provides efficiencies in labor and capital costs involved in managing conventional growing containers, to maximize yield, productive efficiency, and quality of produce.

Plant signaling generally occurs above and below ground in the root zone (rhizosphere). In CEA where plants are grown in individual containers the mechanism for rhizo sphere signaling between plants does not exist.

Plant signaling may occur between plants or micro-organisms and plants, with signaling taking place in the root zone or rhizosphere. In a sterile growing media, or growing media lacking appropriate microbiology, signaling is inhibited.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A plant growing system comprising:
a container comprising:
a base having a top side and a bottom side and formed of a flexible material;
a side wall having an exterior surface and an interior surface and formed of a flexible material, the side wall encircling the perimeter of the base at a first end and extending from the top side of the base and converging towards a seal at the second end;
a cavity formed within the interior surface of the side wall between the base and the seal, the cavity housing horticultural media;
macropores disposed at predefined positions on the base and the side wall; and
micropores disposed at predefined positions on the side wall, and the micropores sized to inhibit fluid exchange between the interior and the exterior of the side wall but sized to permit air exchange between the interior and the exterior of the side wall; and
and upon removing the seal, an opening is formed in the container at the second end, and forming a plant growth container.

2. The plant growing system of claim 1, wherein constituents of the growing media have predetermined water release profiles.

3. The plant growing system of claim 2, wherein the predetermined water release profiles have tension ranges from 0 kPa to 1500 kPa.

4. The plant growing system of claim 1, wherein the distribution of micropores and macropores is based on container size.

5. The plant growing system of claim 1, wherein the distribution of micropores and macropores is based on the growing media.

6. The plant growing system of claim 1, wherein the distribution of micropores and macropores is based is based on a desired planting.

7. The plant growing system of claim 1, wherein the container size is based on the desired planting.

8. The plant growing system of claim 1, further comprising:
a stacking container comprising:
a top and a bottom between a front side opposite a back side, the top and bottom sealed at a first end and a second end, and forming a cavity between the top and bottom and the front side and the back side, the cavity housing horticultural media;
macropores disposed at predefined positions on the base and the side wall;
micropores disposed at predefined positions on the top, bottom, and the back side, and the micropores sized to inhibit fluid exchange between the interior and the exterior of the second container but sized to permit air exchange between the interior and the exterior of the second container;
a plurality of sealed openings on the top;
wherein the container comprises a plurality of containers, each having a planting; and
wherein one of the plurality of containers is placed into each of the plurality of sealed openings, once unsealed.

9. The plant growing system of claim 8, wherein constituents of the growing media of the stacking container have predetermined water release profiles.

10. The plant growing system of claim 8, wherein the predetermined water release profiles have tension ranges from 0 kPa to 1500 kPa.

11. The plant growing system of claim 8, wherein plant allelopathy is promoted.

12. A method for growing plants by container stacking comprising:
providing a plurality of containers having a flexible material, the container further having a plurality of air and water exchange pores disposed throughout the flexible material and a cavity defined by the contours of the flexible material;
providing a volume of growing media disposed inside the cavity;
providing a stacking container having a flexible material having a plurality of sealed openings, the container further having a plurality of air and water exchange pores disposed throughout the flexible material and an interior cavity defined by the contours of the flexible material, the interior cavity containing growing media;
placing a selected planting in contact the growing media of the container;
creating an opening in the stacking container;
placing the container onto the opening of the stacking container;
providing drainage by the macropores and disposing the macropores throughout the base and side wall in positions where evaporation is minimal for a selected planting;
providing air exchange by the micropores and disposing the micropores throughout the side wall in positions where air exchange is encouraged and evaporation is discouraged for the selected planting; and
promoting plant allelopathy.

13. A plant growing system, comprising:
a stacking container comprising:
a top and a bottom between a front side opposite a back side, the top and bottom sealed at a first end and a second end, and forming a cavity between the top and bottom and the front side and the back side, the cavity housing horticultural media;
macropores disposed at predefined positions on the base and the side wall;
micropores disposed at predefined positions on the top, bottom, and the back side, and the micropores sized to inhibit fluid exchange between the interior and the exterior of the second container but sized to permit air exchange between the interior and the exterior of the second container;
a plurality of sealed openings on the top.

14. The plant growing system of claim 13, wherein constituents of the growing media have predetermined water release profiles.

15. The plant growing system of claim 14, wherein the predetermined water release profiles have tension ranges from 0 kPa to 1500 kPa.

16. The plant growing system of claim 13, further comprising a planting within each of the plurality of sealed openings, upon unsealing.

17. The plant growing system of claim 13, wherein plant allelopathy is promoted.

18. The plant growing system of claim 13, further comprising:
a plurality of containers comprising:
a base having a top side and a bottom side and formed of a flexible material;
a side wall having an exterior surface and an interior surface and formed of a flexible material, the side wall encircling the perimeter of the base at a first end and extending from the top side of the base and converging towards a seal at the second end;
a cavity formed within the interior surface of the side wall between the base and the seal, the cavity housing horticultural media;
macropores disposed at predefined positions on the base and the side wall; and
micropores disposed at predefined positions on the side wall, and the micropores sized to inhibit fluid exchange between the interior and the exterior of the side wall but sized to permit air exchange between the interior and the exterior of the side wall;
and upon removing the seal, an opening is formed in the plurality of containers at the second end, and forming a plant growth container;
wherein one of the plurality of containers is placed into each of the plurality of sealed openings, upon unsealed.

19. The plant growing system of claim 18, wherein plant allelopathy is promoted.
